(19) United States
(12) Patent Application Publication
(10) Pub. No.: US 2014/0238080 A1
(43) Pub. Date: Aug. 28, 2014

(54) Systems and Techniques For Fabricating Optical Fiber Gratings

(71) Applicant: OFS Fitel, LLC, Norcross, GA (US)

(72) Inventors: Lars Gruner-Nielsen, Copenhagen (DK); Jorgen Ostgaard Olsen, Copenhagen (DK)

(21) Appl. No.: 14/349,246

(22) PCT Filed: Oct. 9, 2012
(86) PCT No.: PCT/US12/59271

§ 371 Date: Apr. 2, 2014

Related U.S. Application Data
(60) Provisional application No. 61/543,973, filed on Oct. 6, 2011.

(51) Int. Cl. C03B 37/15

(52) U.S. Cl. CPC C03B 37/15; C03B 2203/06
USPC 65/384; 65/402; 65/508

(57) ABSTRACT

A resistive heating element is used to fabricate a long-period grating mode converter. The resistive heating element creates a localized heating zone for creating an asymmetric perturbation at a periodic series of axial locations along the length of a segment of optical fiber that supports the propagation of both a symmetric mode and an asymmetric mode. In a further technique, a grating is written with an index contrast value that is higher than a selected optimum value. The heating element is then used to anneal the fiber segment so as to reduce the contrast value of the grating to the selected optimum value.

### CROSS REFERENCE TO RELATED APPLICATION

The present application claims the priority benefit of U.S. Prov. Pat. App. No. 61/543,973, entitled “Modified Method for Making Long-Period Gratings in Optical Fibers using Electrical Resistive Heating,” filed on Oct. 6, 2011, which is owned by the assignee of the present application and which is incorporated by reference herein in its entirety.

### BACKGROUND OF THE INVENTION

1. Field of the Invention

The present invention relates generally to optical fiber devices and methods and, in particular, to improved systems and techniques for fabricating optical fiber gratings with asymmetric perturbations.

2. Background Art

Mode-division-multiplexed transmission in few-moded fibers has recently attracted a lot of attention as a means of increasing the transmission capacity of a single fiber. The simplest few-moded fibers support two modes: the LP₀₁ mode and the LP₁₁ mode. If all the degenerations of these modes are used, these fibers will support the transmission of 6 channels.

A key component in a mode-division-multiplexing system is a mode converter, i.e., a device that provides efficient and stable conversion between waveguide modes. A mode converter can be implemented using a long-period grating (LPG), which is an optical fiber device comprising a periodic series of perturbations in the fiber's refractive index profile, geometry, or both.

A successful LPG design must satisfy a number of criteria. Of course, the LPG must efficiently produce the desired mode output from a given input. In addition, the LPG must also be stable over an extended period time, and should also display an acceptably low level of insertion loss. Other important factors are cost and ease of manufacture.

Earlier techniques for fabricating LPGs typically fall short in meeting one or more of the above criteria, particularly with respect to provide mode conversion between a symmetric mode, such as the LP₀₁ mode, and an asymmetric and symmetric mode, such as the LP₁₁ mode. Thus, there exists a need for an improved method for fabricating successful optical gratings.

### SUMMARY OF THE INVENTION

Aspects of the invention are directed to systems and techniques for fabricating a long-period grating that provide efficient and stable mode conversion between a symmetric waveguide mode and an asymmetric waveguide mode.

An aspect of the invention is directed to a technique for writing an optical device, such as a long period grating, into an optical fiber. There are provided a segment of optical fiber and a heating unit that includes a resistive heating element specifically configured to have a thickness that is smaller than a selected period for the optical device, wherein the resistive heating element creates a localized heating zone having a width that is narrower than the selected device period, and wherein applying heat causes a localized, rotationally asymmetric perturbation in the selected portion of the fiber segment.

The fiber segment is mounted so that a side surface of the fiber segment is proximate to a side surface of the resistive heating element. A translation stage is provided for at least one of the fiber segment and the heating element, such that a side surface of the fiber segment is axially translatable relative to the heating element. The fiber segment is positioned with respect to the resistive heating element such that a surface of a selected portion of the fiber segment is located in the heating zone of the resistive heating element. The temperature of the resistive heating element is selected so as to cause a rotationally asymmetric perturbation in the selected portion of the fiber segment.

Another aspect is directed to a technique for providing greater control in fabricating an LPG. The above technique is used to write a grating with an index contrast value that is higher than a selected optimum value. The heating element is then used to anneal both perturbed and unperturbed regions of the fiber segment so as to reduce the contrast value of the grating to the selected optimum value.

A further aspect of the invention is directed to a system for performing the above techniques.

### BRIEF DESCRIPTION OF THE DRAWINGS

FIGS. 1A and 1B show simplified scalar representations of the fundamental LP₀₁ mode and the higher-order LP₁₁ mode in an exemplary multimode fiber, and FIGS. 1C and 1D show graphs of the respective electric field intensity distributions for the two modes.

FIG. 2 shows a simplified diagram of a long-period grating.

FIGS. 3 and 4 are diagrams of mechanical gratings for fabricating a long-period grating.

FIG. 5 is a simplified diagram illustrating a setup according to an aspect of the invention for creating a localized, asymmetric index perturbation in an optical fiber segment.

FIG. 6 is a closeup side view, not drawn to scale, of the heating element and a portion of the fiber segment shown in FIG. 5.

FIG. 7 is a further side view of a portion of the fiber segment FIG. 5, illustrating changes to the heated portion of the fiber segment.

FIGS. 8-11 are diagrams illustrating a number of different configurations for the resistive heating element according to further aspects of the invention.

FIG. 12 shows a diagram of an assembly, in accordance with a further aspect of the invention, for controlling the axial movement of a fiber segment relative to a heating element, so as to fabricate a series of asymmetric perturbations in the fiber segment.

FIG. 13A shows a diagram of a complete mode converter.

FIGS. 13B and 14 show diagrams of two testing setups that were used to quantify the performance of an LPG fabricated according to aspects of the invention.

FIG. 15 and FIGS. 16A-16E show transmission spectra obtained using the testing setup shown in FIG. 13B that illustrate the improved stability of an LPG fabricated according to the present invention compared with an LPG fabricated using a mechanical grating.

FIG. 17 is a graph illustrating mode beating amplitude as a function of group delay, as calculated from an S² measurement conducted using the testing setup shown in FIG. 14.

FIG. 18 is a graph illustrating the agreement between the calculated multipath interference and the transmission spectrum of an LPG fabricated according to aspects of the present invention.

FIG. 19 is a graph illustrating the relationship between heating time and perturbation state in an LPG fabricated according to aspects of the present invention.

FIG. 20 is a graph illustrating the decrease in perturbation contrast resulting from the application of an annealing technique to a long-period grating in accordance with a further aspect of the invention.

FIGS. 21A-21F show a series of LP₀₁-to-LP₀₁ transmission spectra for a long-period grating subjected to a series of five annealing passes.

FIGS. 22 and 23 are flowcharts of general techniques according to an aspect of the invention.

### DETAILED DESCRIPTION

Aspects of the invention are directed to systems and techniques for configuring and fabricating a long-period grating (LPG) to provide mode conversion between a symmetric input mode and an asymmetric output mode. The present invention is described in the context of providing mode conversion between the symmetric LP₀₁ mode and the asymmetric LP₁₁ mode in a few-mode fiber (FMF). It will be appreciated that these techniques are also applicable in other contexts to provide mode conversion between other pairs of input and output modes for other types of fibers.

According to an aspect of the invention, a resistive heating element is used to create a series of asymmetric perturbations in a segment of optical fiber. As discussed below, these perturbations can be in the refractive index, in the fiber geometry, or both. A further aspect of the invention is directed to a post writing annealing technique that provides more precise control of circularly asymmetric index perturbations.

Using the described systems and techniques, it has been possible to demonstrate good stability compared to traditional, mechanically-fabricated long period gratings, as well as high coupling efficiency and low insertion loss.

As used herein, the adjectives “symmetric” and “asymmetric” refer to circular symmetry, unless stated otherwise. Thus, as used herein, the term “symmetric mode” (refers to a waveguide mode having an electric field distribution that displays circular (or axial) symmetry in the transverse plane, i.e., symmetry around a point in the transverse plane that is independent of rotational angle. A symmetric mode will have the same appearance at all angles of rotation around a center point (i.e., the origin). As further used herein, the term “asymmetric mode” refers to a waveguide mode that does not display circular symmetry, irrespective of any other types of symmetry that may be present.

A typical optical fiber supports the propagation of light in one or more linear polarization modes Uₗₘ, where l and m are integers indicating, respectively, the number of azimuthal nodes and the number of radial nodes in the mode's transverse intensity distribution.

Generally speaking, an LPₗₘ, mode is symmetric if the mode has zero azimuthal nodes and one or more radial nodes, i.e., if l=0 and m≧1. Thus, the fundamental LP₀₁ mode and the higher order LP₀₂ and LP₀₃ modes are all examples of symmetric modes. An LP mode is circularly asymmetric if it has one or more azimuthal nodes, i.e., if l≧1. Thus, the higher-order LP₁₁, LP₂₁, and LP₃₁ modes are all examples of asymmetric modes.

Certain optical fiber applications require the conversion of a symmetric mode input into an asymmetric mode output. For example, one recently developed mode-division multiplexing (MDM) system requires a symmetric LP₀₁ mode input to be converted into an asymmetric LP₁₁ mode output.

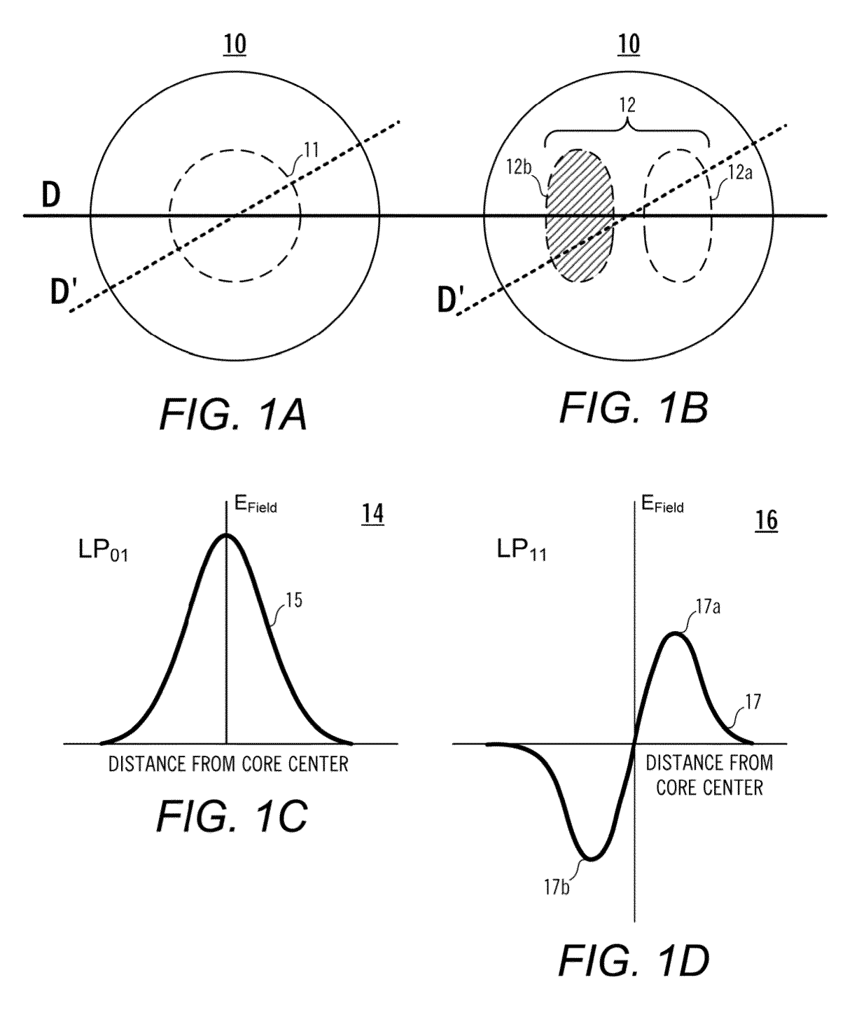

FIGS. 1A and 1B show, respectively, simplified diagrams of a cross section of an exemplary multimode fiber 10, in which there are depicted simplified scalar representations 11, 12 of the respective intensities of the fundamental LP₀₁ mode and the higher-order LP₁₁ mode. FIGS. 1C and 1D show graphs 14 and 16 of the respective electric field distributions 15, 17 for the LP₀₁ and LP₁₁ modes across fiber diameter D.

It will be seen in FIG. 1C that the LP₀₁ electric field distribution 17 has a substantially Gaussian shape. In FIG. 1D, on the other hand, it will be seen that the LP₁₁ electric field distribution has a non-Gaussian shape, comprising two oppositely signed peaks 17a, 17b corresponding to lobes 12a, 12b in FIG. 1B. (Lobe 12b is cross-hatched to indicate its negative value.)

It will be apparent from FIGS. 1A and 1C that the electric field distribution of the LP₀₁ mode is circularly symmetric, because the LP₀₁ mode presents the same electric field distribution across all diameters, irrespective of angular orientation (e.g., across diameter D′). It will further be apparent from FIGS. 1B and 1C that the electric field distribution of the LP₁₁ mode is not circularly symmetric, because the LP₁₁ mode presents different electric field distributions across diameters having different angular orientations (e.g., across diameter D′).

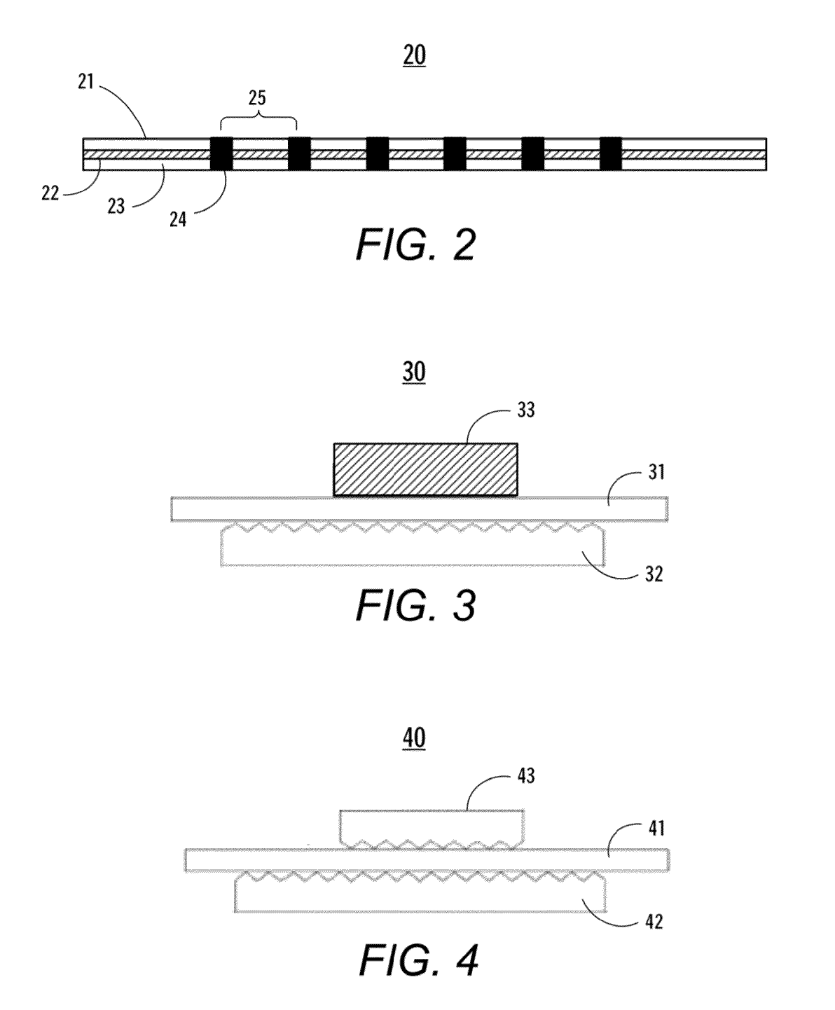

One device that is commonly used to provide mode conversion is a long-period grating (LPG). FIG. 2 shows a simplified diagram of an exemplary LPG 20, not drawn to scale, that is configured to provide mode conversion between a selected input mode and a selected output mode. LPG 20 comprises a segment of optical fiber 21 having a a core 22 and cladding 23, the optical fiber segment 21 configured to support the propagation of both the input mode and the output mode. The LPG further comprises a series of index perturbations 24, having a center-to-center spacing 25 that defines the grating period.

Generally speaking, LP modes are orthogonal and thus, in the absence of perturbations, do not interact with each other. The periodic perturbations in LPG 24 are configured to produce a scattering of an input mode. At least some of the scattered light is phase-matched with a selected output mode, resulting in excitation of the output mode.

The conversion efficiency of an LPG is given by

$$\frac{{P}_{lm}^{out}}{{P}_{01}^{in}} = \frac{{sin}^{2} ( κ L \sqrt{1 + {( \frac{δ}{κ} )}^{2}} )}{1 + {( \frac{δ}{κ} )}^{2}} , \\ where \\ δ = \frac{1}{2} [ \frac{2 π}{λ} ( {n}_{01}^{eff} - {n}_{lm}^{eff} ) - \frac{2 π}{Λ} ] , \qquad Eq . ( 1 )$$

Here:
is the LP₀₁ power at the input of the LPG;
is the power in LPₗₘ at the output of the LPG;
L is the length of the LPG;
λ is the wavelength;
is the effective index of the LP₀₁ mode;
is the effective index of the LPₗₘ mode;
is the grating period; and
κ is the coupling coefficient given by:

$$κ \sim \frac{1}{λ} {\int }_{0}^{2 π} {\int }_{0}^{∞} {E}_{01} {E}_{lm} p ( r , φ ) d r d φ , \qquad Eq . ( 2 )$$

where
E₀₁ is the electric field distribution of the LP₀₁ mode;
Eₗₘ is the electric field distribution of the Lₗₘ mode; and
p(r,φ) is the perturbation function.

From Eq. (2), it follows that in order to achieve efficient coupling between LP₀₁ and an asymmetric mode, such as LP₁₁, an asymmetric perturbation is needed. (Without an asymmetric perturbation, Eq. (2) would result in a value for κ of 0.)

The need for an asymmetric perturbation can be understood intuitively by returning to FIGS. 1C and 1D, discussed above, which illustrate the respective electric field distributions 15, 17 of the LP₀₁ and LP₁₁ modes. Coupling to the LP₁₁ mode requires the transfer of energy to both the positive and negative portions of the LP₁₁ electric field distribution 17. However, the LP₀₁ electric field distribution 15 has only positive values. Coupling the LP₀₁ mode to the LP₁₁ mode in the absence of an asymmetric perturbation is impossible because it would require, in essence, that only positive values be multiplied together to generate both positive and negative values. An asymmetric perturbation can be conceptualized as introducing a negative component into the mode coupling function.

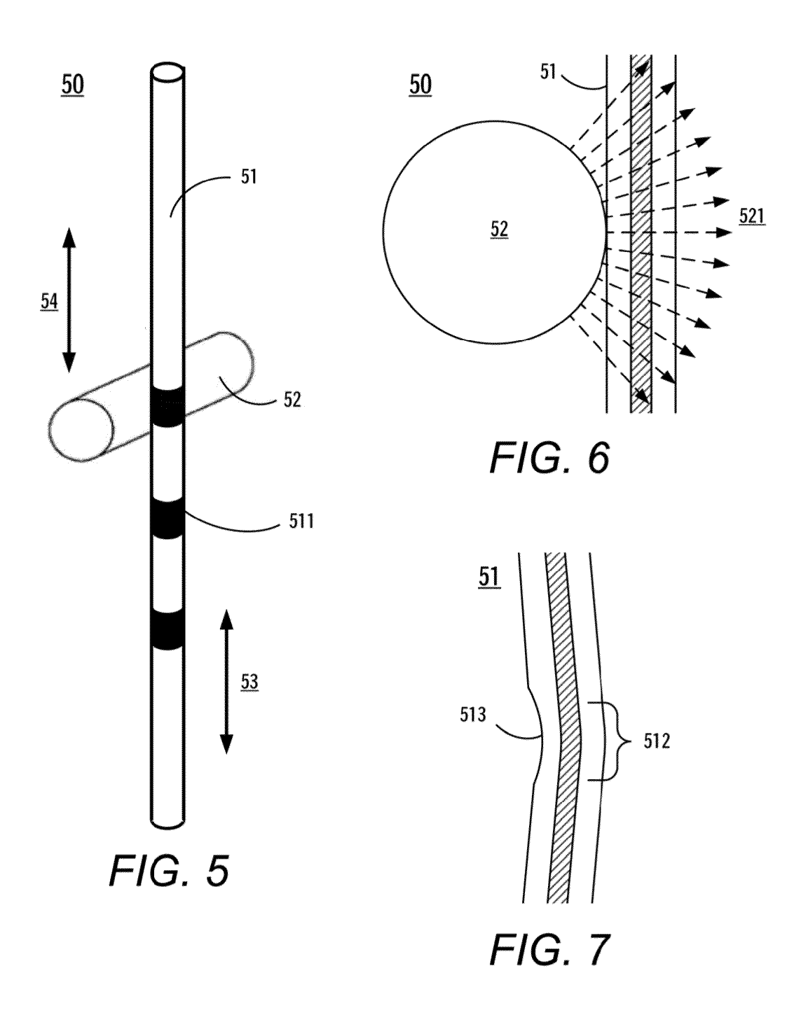

An asymmetrically perturbed LPG can be created in a number of different ways. FIG. 3 is a diagram of an LPG 30, in which asymmetric perturbations are created by pressing a fiber segment 31 between a grating 32 and a rubber block 33. By varying the angle between fiber 31 and grating 32, the deformation period can be tuned. However, due to the viscoelastic nature of the rubber block 33, the fiber deformations are not stable over time.

FIG. 4 is a diagram of an LPG 40 in which asymmetric perturbations are created by pressing a fiber segment 41 between a first mechanical grating 42 and a second mechanical grating 43. While LPG 40 (FIG. 4) displays improved stability compared with LPG 30 (FIG. 3), LPG 40 also lacks stability over time. One reason for the lack of stability is the fiber's viscoelastic coating. Stability could possibly be improved by removing the coating from the fiber, but this is not a durable solution from a reliability point of view.

Improved stability can be achieved by permanently writing perturbations directly into a fiber segment, compared to creating them by mechanically pressing or indenting a fiber segment as discussed above. In addition, such an LPG has a significantly smaller size. One way to create an asymmetric perturbation in a fiber segment is by using a CO₂ laser to apply heat from one side. However, such a technique requires the use of expensive equipment that potentially presents a hazard to workers.

According to an aspect of the invention, a resistive heating element (i.e., a filament or strip of material that emits heat when conducting electricity) is used to apply heat to a series of locations along one side of an optical fiber segment, so as to create a periodic series of asymmetric perturbations in the fiber.

The perturbations are configured in accordance with equations (1) and (2), above, so as to provide mode coupling between a symmetric mode and an asymmetric mode. A resistive heating element is simpler and significantly cheaper than a CO₂ laser, and is also significantly safer to operate. Like perturbations written using a CO₂ laser, the perturbations created using the techniques described herein are permanent, and thus result in LPGs that are significantly more stable than LPGs created using mechanical methods.

It is noted that a technique for using a resistive heating element to fabricate an LPG is described in U.S. Pat. No. 7,486,858, which is owned by the assignee of the present application. However, according to the technique described therein, a fiber segment is threaded through a hole in the resistive heating element. The perturbation that results is symmetric. Thus, as set forth in equation (2), discussed above, the technique described in U.S. Pat. No. 7,486,858 is not suitable for fabricating a mode converter between a symmetric mode and an asymmetric mode.

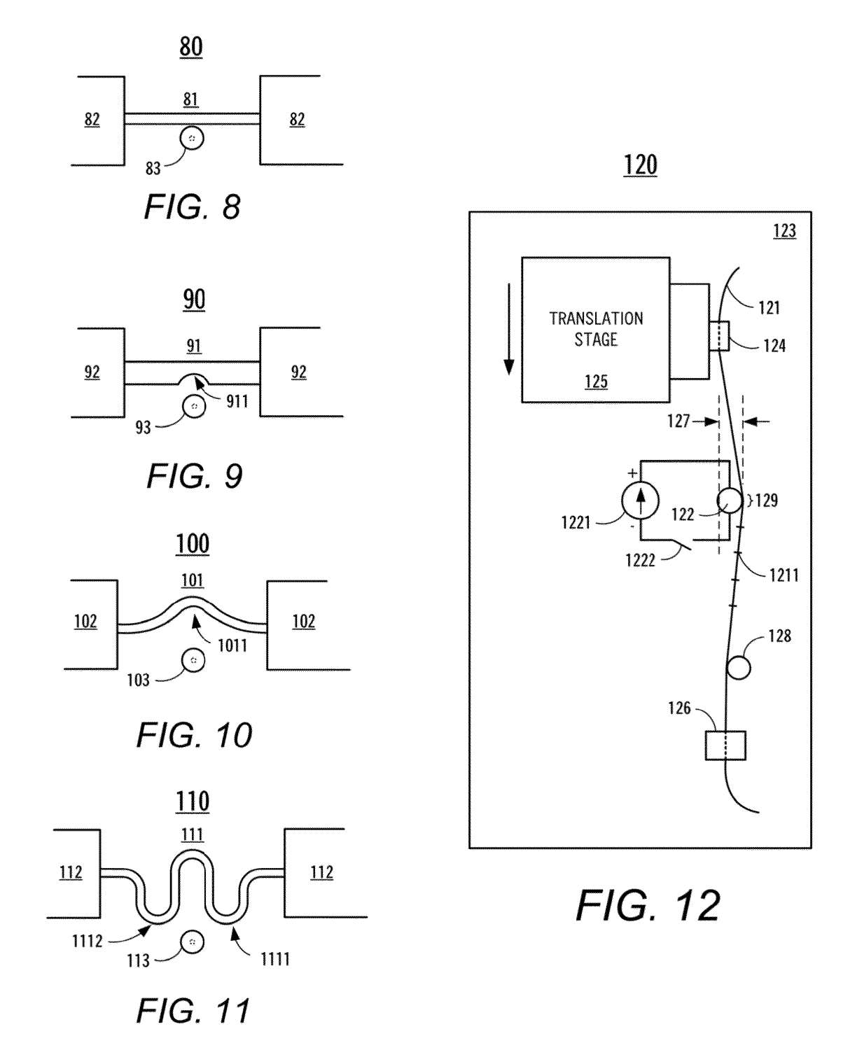

FIG. 5 is a simplified diagram illustrating a setup 50 according to an aspect of the invention for creating localized perturbations 511 in an optical fiber segment 51. The setup comprises a resistive heating element 52, fabricated from a suitable material such as Kanthal (FeCrAl) or platinum. In the present example, the resistive heating element is a wire having a cylindrical shape, i.e., a circular outer profile. However, the invention may also be practiced using a heating element having different shapes.

Setup 50 is configured to allow a fiber segment 51 to be positioned along one side of the heating element 52, such that the fiber 51 and the heating element 52 are substantially perpendicular to each other and are sufficiently close together, or abutting each other. This allows for the heat from the heating element 52 causes an asymmetric perturbation in the fiber segment 51 at a series of selected axial locations 511.

Setup 50 is further configured to allow for controlled movement of either the fiber segment or the heating element, or both, relative to each other, thereby allowing the heating element 52 to be moved to each perturbation site 511. This controlled movement may, for example, provide an upward and/or downward movement of the fiber segment 51 relative to the heating element 52, represented by double-headed arrow 53, or an upward or downward movement of the heating element 52 relative to the fiber segment 51, represented by arrow 54, or some combination thereof. During the movement, the fiber is kept straight without twisting.

The described relative movement can be accomplished, for example, by creating a stationary mount for the heating element 52 and a translational mount for the fiber segment 51. Alternatively, the fiber can be provided with a stationary mount, and the heating element can be provided with a translational mount. It would also be possible for both the heating element and the fiber segment to be provided with translational mounts.

The perturbations are spaced apart in accordance with the selected grating period. The resistive heating element has a width or thickness that is less than the grating period, and, thus, generates a heating region that is narrower than the grating period. The amount of heat should be sufficiently high to achieve the desired result. For example, temperatures of approximately 1,500° C. or higher will typically be required in order to create a localized softening in an exemplary silica optical fiber. A somewhat lower temperature, estimated to be in the range of 1,000° C. to 1,100° C., may be sufficient to release stresses in the fiber.

It is noted that, as a practical matter, it is typically not necessary to know the exact temperatures for the resistive heating element. The various parameters used in the grating fabrication process can be determined empirically, through trial and error. The temperatures set forth herein are intended to provide guidance as to the type of equipment and materials that can suitably be used to implement practices of the invention, and to provide a general idea as to possible starting points in the development of a set of fabrication parameters for a given application.

It is further noted that an optical fiber is typically provided with a protective outer coating. In practicing the described techniques, it is contemplated that the outer coating may be removed prior to heating.

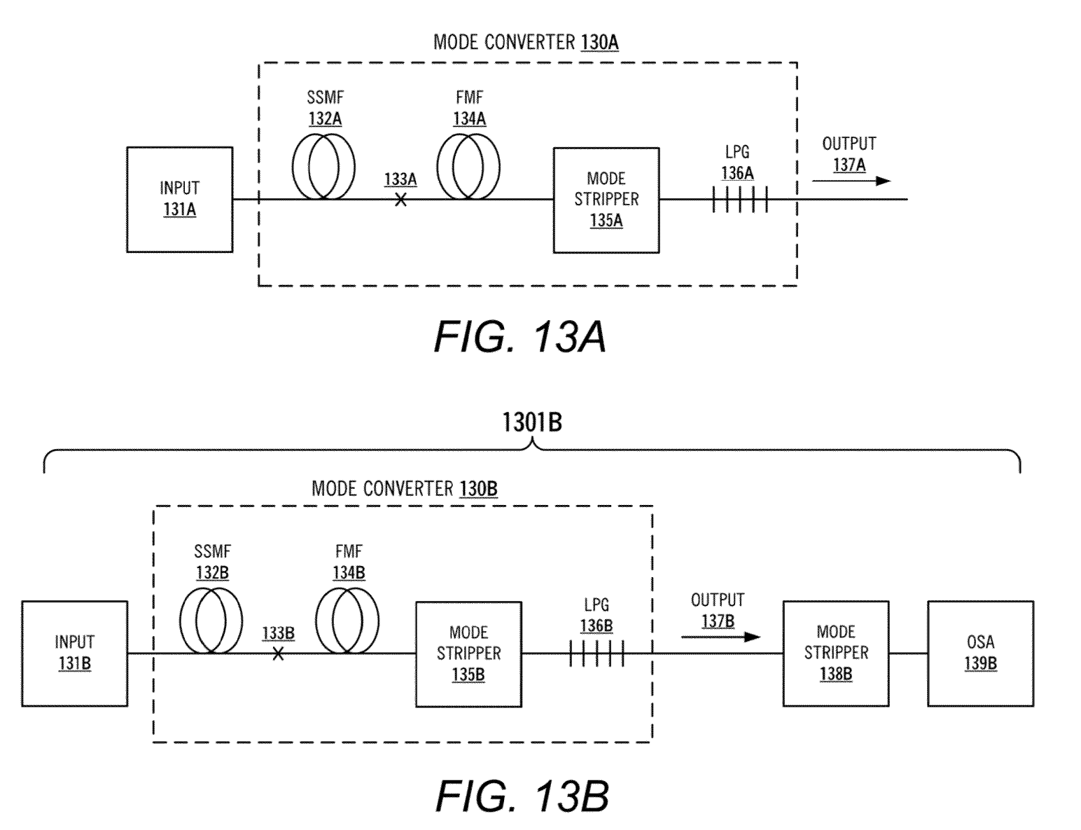

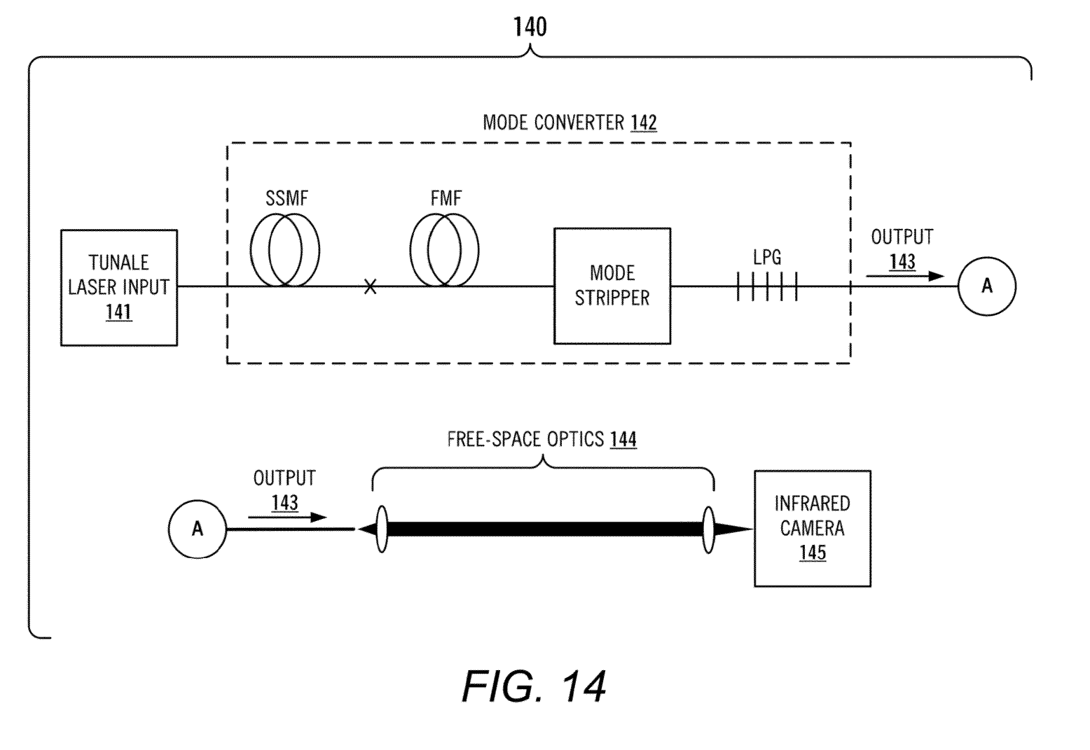

FIGS. 6 and 7 are simplified diagrams, not drawn to scale, that illustrate how the described heating technique can create an asymmetric perturbation in refractive index, an asymmetric perturbation in fiber geometry, or a combination thereof.

FIG. 6 is a closeup side view of system 50, not drawn to scale, showing the heating element 52, which abuts the fiber segment 51, creating a heating zone 521, in which heat is applied asymmetrically to a local portion of fiber segment 51. It would also be possible for the heating element 52 to be proximate to fiber segment 51, rather than abutting it. In that case, other structures may be required to ensure precise positioning of the fiber segment 51 within the heating zone 521.

The temperature of the heating element is sufficient to result in a local softening of the fiber segment. In the examples described herein, the heating element reached temperatures estimated to be in the range of 1,400° C. to 1,600° C. FIG. 7 is a further side view, not drawn to scale, after heating has been completed, illustrating changes to the heated portion of the fiber segment.

The application of heat to the fiber segment 511 causes two things to happen, each of which results in an asymmetric perturbation in the heated fiber region, as shown in FIG. 7.

First, heat applied by the resistive heater 52 causes an asymmetric relaxation of the draw-induced stresses in the heated fiber region, and which results in a slight asymmetric increase 512 in the length of the core in the heated region, as shown in FIG. 7. Because of the elasto-optic effect, differences in stresses and core length results in perturbation of the refractive index profile. Because the differences in stresses and core length are asymmetric, the resulting perturbation is also asymmetric.

Second, also shown in FIG. 7, the heat applied by the resistive heating element 52 causes a notch 513 to be melted into the fiber segment 54 at the point of contact, thereby significantly reducing the cladding diameter. Because notch 62 is asymmetric, the perturbation resulting from notch 62 is also asymmetric.

Thus, the described heating technique can be used to create an asymmetric perturbation either in the core refractive index or in the fiber geometry, or a combination thereof.

According to an aspect of the invention, the resistive heating element 52 is implemented using a length of material fabricated from a resistive material able to retain its structural integrity when operating at a temperature sufficient to soften a local portion of an optical fiber. As mentioned above, such materials include, for example, platinum and Kanthal (FeCrAl), which are able to withstand temperatures on the order of 1,000° C. or greater. As further mentioned above, in the present examples the resistive heating element 52 is implemented using a wire with a circular outer profile. However, it would also be possible to use a differently-shaped resistive element, including a strip or plate.

In the presently described examples, the resistive heating element is provided by a length of platinum wire. The diameter of the heating element should be less than the selected grating period. As discussed below, satisfactory results were obtained using a platinum wire having a diameter of 0.5 mm to fabricate a grating having a period of 1.17 mm. It was also possible to make a LPG using a Kanthal filament with a dimension of 1.25 mm×0.15 mm. Platinum seems preferable due to the ability to withstand higher temperatures than Kanthal.

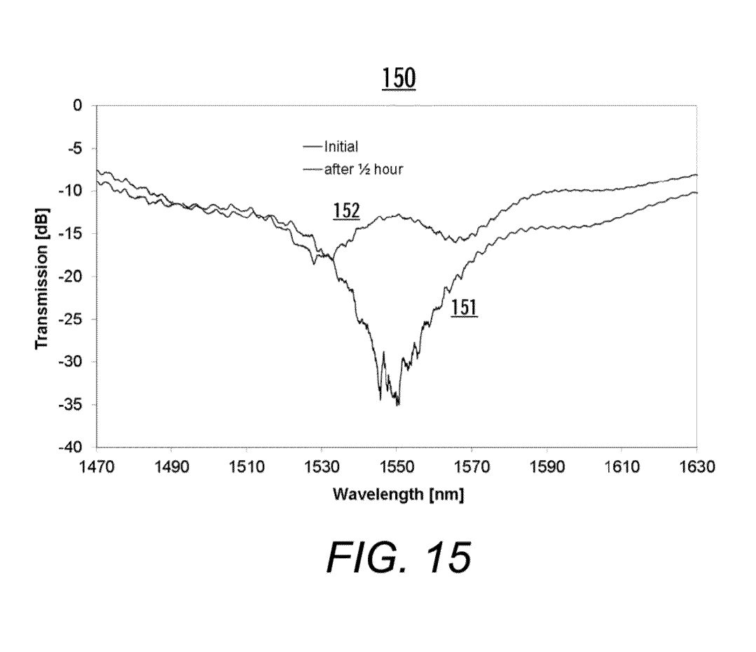

FIGS. 8-11 are simplified diagrams of a number of different configurations for the resistive heating element according to further aspects of the invention.

FIG. 8 shows a basic configuration 80, in which a straight platinum wire 81 is connected between a pair of electrode blocks 82. Alternatively, a Kanthal heating filament can be connected between the electrode blocks 82 in place of platinum wire 81.

FIG. 9 shows a second configuration 90, which a Kanthal heating filament 91 is connected between a pair of electrode blocks 92. A notch 911 has been cut into one side of the heating filament 91 in order to provide a guiding track for the optical fiber 93 to be thermally treated.

FIG. 10 shows a third configuration 100, in which a platinum wire 101 has been connected between the electrode blocks 102. The wire 101 has been bent into a curved shape to provide guidance for the optical fiber segment 103.

FIG. 11 shows a fourth configuration 110, in which a platinum wire 111 has been connected between the electrode blocks 112. The wire has been bent into a “W” shape that is configured to accommodate thermal expansion of wire 111 during heat treatment. When current is applied to the wire 111 it expands in length while the electrode blocks 112 remain stationary. In the configuration shown in FIG. 10, the thermal expansion of wire 101 will typically result in movement of the contact point between the fiber 103 and wire 101. In the “W” shape configuration of wire 111 (FIG. 11) the bends 1111 and 1112 can accommodate the extra length, and thus maintain a more stable contact point between fiber 113 and wire 111 and consequently a more constant heat transfer from wire 111 to fiber 113.

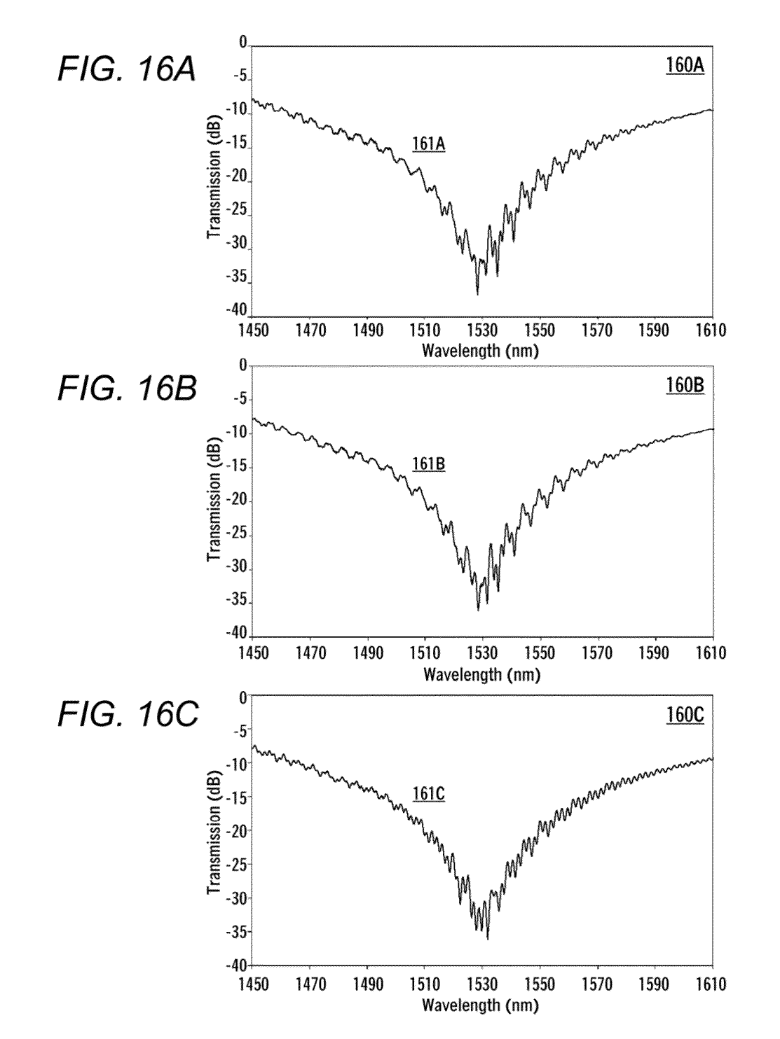

FIG. 12 shows a diagram of an assembly 120, in accordance with a further aspect of the invention, for controlling the axial movement of a fiber segment 121 relative to a heating element 122, so as to fabricate a series of asymmetric perturbations 1211 in the fiber segment.

In assembly 120, chassis 123 provides a structural foundation of the other assembly components.

Heating element 122 is represented in side view and may be implemented one of the heating element configurations illustrated in FIG. 8-11. In the depicted example, heating element 122 is connected to a pair of electrode blocks (not shown) that are connected to a current source 1221 controlled by a suitable switch 1222.

The tail end of fiber segment 121 is held by a fiber clamp 124 that is mounted to a translation stage 125 that is translatable in an up-down direction. A small weight 126 is attached to the lead end of the fiber segment.

The heating element 122 is positioned under the fiber clamp 124, such that the weighted fiber is displaced from vertical by an offset 127. A guide roller 128 is positioned under the fiber clamp and the heating element such that the pull on the fiber by the attached weight caused the heated portion 129 of the fiber segment to be gently pressed against the heating element 124.

Once the fiber has been loaded, switch 1222 is closed, and a portion of the fiber is heated for a selected amount of time. The switch is then opened, and the translation stage is used to lower the fiber by a selected distance, i.e., the grating period. The process is repeated until the desired number of grating perturbations has been created.

It is also possible for switch 1222 to remain closed for the entire inscription process. In that case, after each individual perturbation has been inscribed, the fiber is quickly advanced to the next perturbation site. It is noted that this is the technique that was used to fabricate the exemplary gratings described herein. Care must be taken to ensure that excessive heat is not applied to any of the perturbation sites, and that no perturbations are introduced into the fiber segment portions in between the perturbation sites.

Weight 126 causes the fiber 121 to be pressed against the heating element 122 with a constant force, insuring adequate thermal contact that is stable throughout the fabrication process. Good results were obtained using a weight of 2.5 g.

Tests were conducted of LPGs fabricated according to aspects of the invention, including tests comparing these LPGs with LPGs fabricated using other techniques.

The tested grating was constructed as follows:

The fiber used was a few-mode fiber (FMF) having a core diameter of 19 μm and having only two guided modes: the LP₀₁ mode and the LP₁₁ mode. A platinum wire with a diameter of 0.5 mm was used as the resistive heating element. The 0.5 mm diameter platinum wire creates a heating region that is narrower than the grating period. The amount of heat generated was sufficient to create a localized softening of the optical fiber, and is estimated to have a temperature in the range of 1,400° C. to 1,600° C.

The platinum wire heating element was formed into a W-shape and connected between a pair of electrodes in accordance with the practice of the invention illustrated in FIG. 11, discussed above. The movement of the fiber segment relative to the heating element was controlled using an assembly of the type illustrated in FIG. 12. The current through the platinum wire was 11 A. The fiber was kept still for 8 sec and the moved to next position in 0.2 sec. The period was 1.17 mm. 9 periods were made corresponding to a grating length of 10.5 mm.

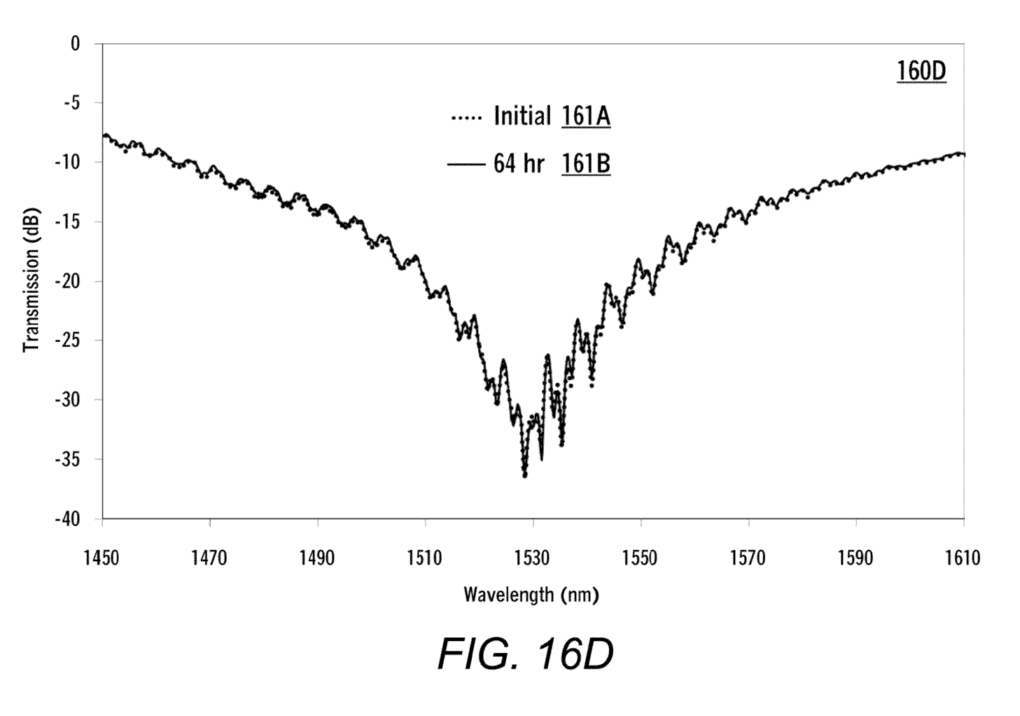

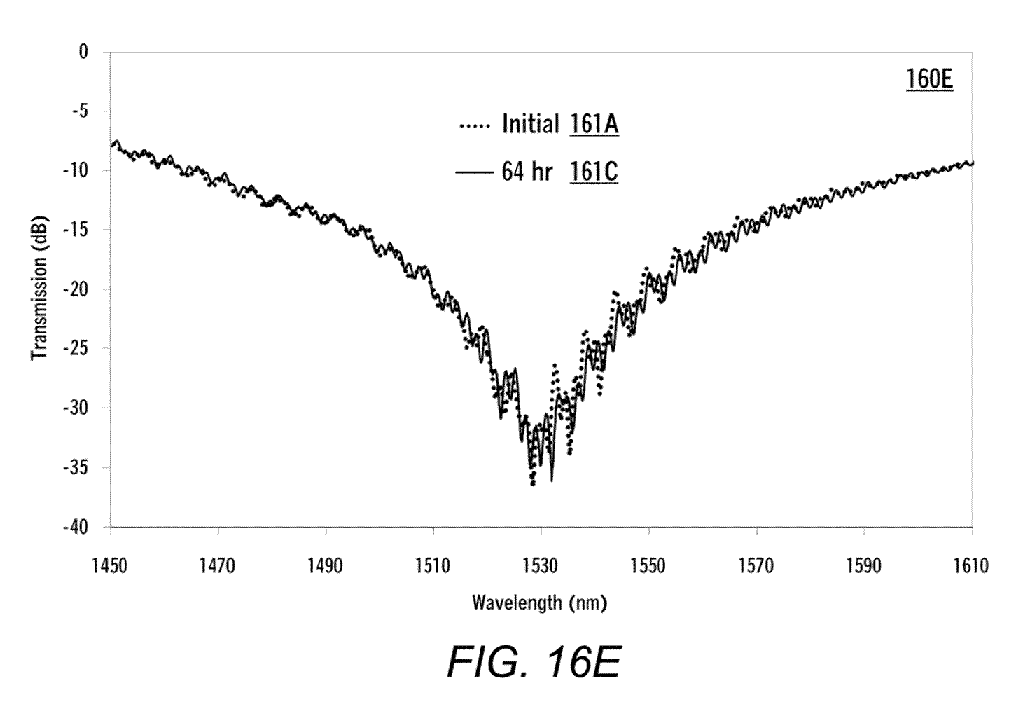

An LPG fabricated in accordance with the above-described techniques was assembled into a complete mode converter 130A illustrated in FIG. 13A.

Mode converter 130A provides LP₀₁-to-LP₁₁ mode conversion for laser light emitted by input 131A, and comprises the following elements: a length of a standard single-mode fiber (SSMF) 132A having an input end connected to input 131A; a length of a few-mode fiber (FMF) 134A having an input end connected at splice 133A to the output end of SSMF 132A; a mode stripper 135A having an input end connected to the output end of FMF 134A; and an LPG 136A fabricated according to the above-described techniques, having an input end connected to the output end of FMF 134A. The mode converter output 137A is emitted from the output end of LPG 136A.

FIGS. 13B and 14 show diagrams of two testing setups 1301B and 140 that were used to quantify the performance of LPG mode converters fabricated in accordance with aspects of the invention.

In FIG. 13B testing setup 1301B comprises a mode converter 130B with elements 132B-136B corresponding to components 132A-136A of the mode converter 130A shown in FIG. 13A, including an LPG 136B fabricated in accordance with the above-described techniques.

Mode converter 130b receives broad bandwidth light from input 131B, and provides a mode-converted output 137B to mode stripper 138B, which is connected to optical spectrum analyzer (OSA) 139B. The mode properties of LPG 136B are isolated by mode strippers 135B and 138B.

In the FIG. 14, testing setup 140 comprises a tunable laser input 141 that launches a tunable input light into a mode converter 142 corresponding to mode converters 130A and 130B, as shown in FIGS. 13A and 13B. The mode converter output 143 is provided as a beam output 143 into free-space optics 144. The output of the free-space optics 144 is then focused onto an infrared camera 145.

It is noted that testing setup 140 is a modified version of an imaging system and technique described in U.S. Pat. No. 7,817,258, which is owned by the assignee of the present application, and is incorporated herein by reference in its entirety. The imaging system and technique are referred to herein as “S² imaging,” which is an abbreviation for “spatially and spectrally resolved imaging.” S² imaging proved to be an effective and fast tool for characterization of the mode converters.

The insertion loss of the complete mode converter 130A shown in FIG. 13A was measured to 0.47 dB. The variation in insertion loss between 1500 nm and 1620 nm was within the measurement uncertainty. The main contribution to the insertion loss is from the splice 133A between the SSMF and the few-mode fiber. In the test, the splice 133A was difficult to optimize due to the large difference in mode field diameter, at 1550 nm, from 10.5 μm for the SSMF to 14.9 μm for LP₀₁ of the two-moded fiber.

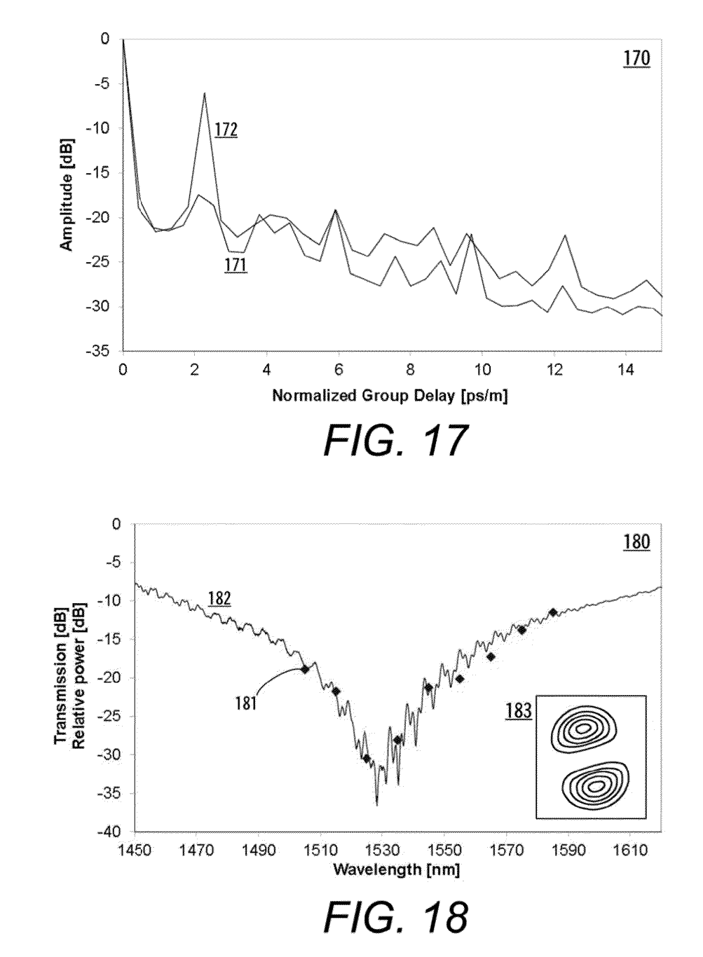

FIG. 15 shows a graph 150 of two LP₀₁-to-LP₀₁ transmission spectra 151 and 152 of a mechanically fabricated LPG of the type illustrated in FIG. 4. The spectra were generated using the testing setup 1301B (FIG. 13B). Spectrum 151 was recorded when the LPG was initially fabricated; spectrum 152 was recorded after ½ hour. The marked difference between the two spectra indicates the LPG's lack of stability.

FIGS. 16A through 16C are a series of graphs 160A, 160B, 160C, showing respective plots 161A, 161B, 161C of three LP₀₁-to-LP₀₁ transmission spectra of an LPG fabricated in accordance with the present invention. The type of fiber and the testing setup were the same as those used to generate the spectra in FIG. 15. The heating element shown in FIG. 11, and the translation assembly shown in FIG. 12 were used to fabricate the LPG, which had a 10 perturbations (9 periods), and a perturbation period of 1.17 mm. Spectrum 161A (FIG. 16A) was recorded at the time of fabrication; spectrum 161B (FIG. 16B) was recorded after 16 hours; and spectrum 161C (FIG. 16C) was recorded after 64 hours.

FIGS. 16D and 16E show graphs 160D and 160E that are provided in order to illustrate the closeness of spectra 161A, 161B, and 161C to each other, which demonstrates the stability of the LPG. In graph 160D (FIG. 16D), spectrum 161B (solid line) has been superimposed on top of spectrum 161A (dotted line), and illustrates how little the LP₀₁-to-LP₀₁ spectrum has changed between the time of fabrication and 16 hours later. In graph 160E (FIG. 16E), spectrum 161C (solid line) has been superimposed on top of spectrum 161A (dotted line), and illustrates how little the LP₀₁-to-LP₀₁ spectrum has changed between the time of fabrication and 64 hours later. Thus, both FIGS. 16D and 16E demonstrate the stability of the LPG created using the inventive methods.

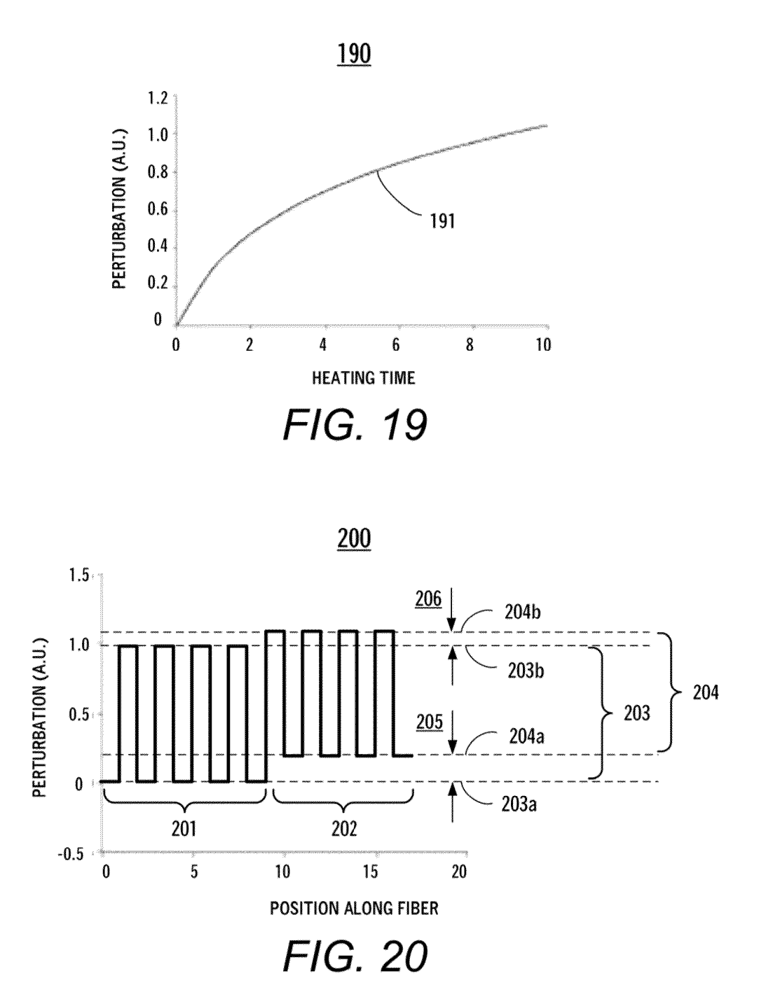

FIG. 17 is a graph 170 illustrating mode beating amplitude as a function of group delay at a first wavelength range, 1520 nm to 1530 nm (lower plot 171), and at a second wavelength range 1580 nm to 1590 nm (upper plot 172). Generally speaking, mode beating is a type of noise resulting from the interaction between modes. Thus, graph 170 illustrates the mode beating resulting from the interaction of the LP₀₁ and LP₁₁ modes created by an LPG.

The modified S² setup shown in FIG. 14 was used to generate graph 170. The modified S² setup allows for very fast measurements. Camera images corresponding to 100 wavelength points were taken in 22 seconds. Plots 171 and 172 are based on measured mode beating averaged over all camera pixels as a function of group delay difference, normalized to the fiber length.

Graph 17 shows a clear peak at 2.2 ps/m, corresponding to residual LP₀₁. It is also observed that this peak is much smaller in the 1520 nm to 1530 nm range (plot 171) than in the 1580 to 1590 nm range (plot 172). The remaining peaks in FIG. 17 result from noise due to weak reflections in the setup, leading to coupling into the camera.

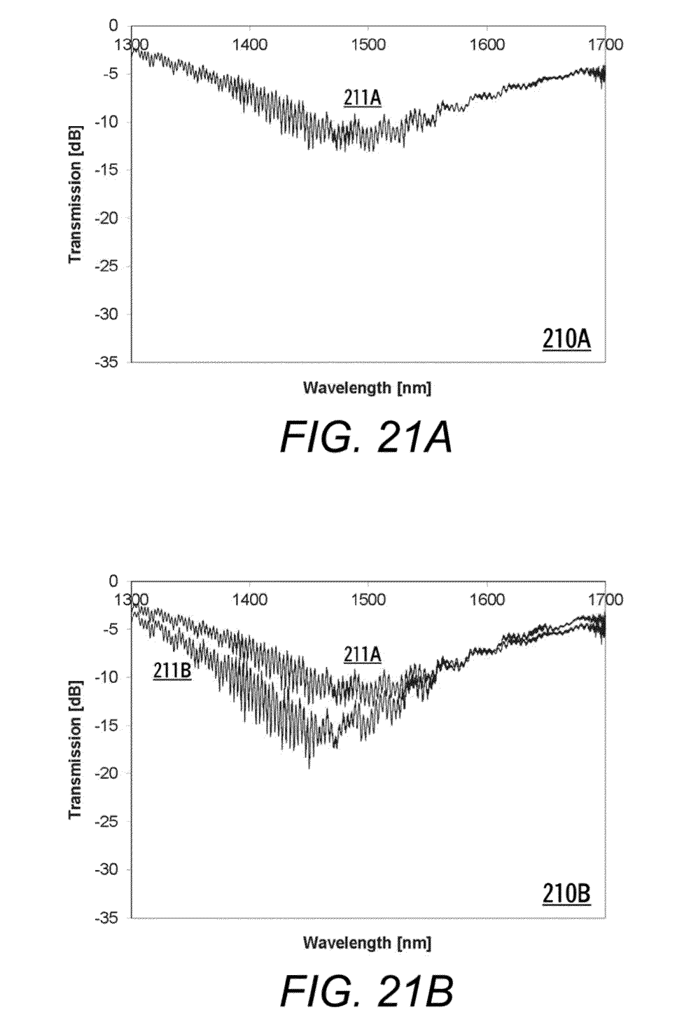

FIG. 18 is a graph 180 illustrating the agreement between: (1) the calculated multipath interference (MPI) of the mode converter calculated from S² measurement (black diamonds 181); and (2) the transmission spectrum (plot 182) measured using the setup shown in FIG. 13B. Inset 183 shows a simplified line drawing of the measured mode pattern from the mode converter at 1525 nm.

The transmission spectrum was measured from LP₀₁-to-LP₀₁, with mode strippers on both sides of the LPG. The MPI of mode converter is calculated from the S² measurement, where MPI is defined as:

$$MPI = 10 \cdot log ( \frac{{P}_{par}}{{P}_{tot}} )$$

where
Pₚₐᵣ is power in the parasitic mode (LP₀₁ in this case); and
Pₜₒₜ is the total power.

In graph 180, the MPI 181 was calculated based on the results of S² scans conducted at intervals of 10 nm. Graph 180 shows a good agreement between the measured LP₀₁-to-LP₀₁ transmission spectrum (plot 182) and the calculated MPI (black diamonds 181). It has been observed that MPI is below −25 dB between 1520 nm and 1540 nm, and below −20 dB between 1510 nm and 1550 nm.

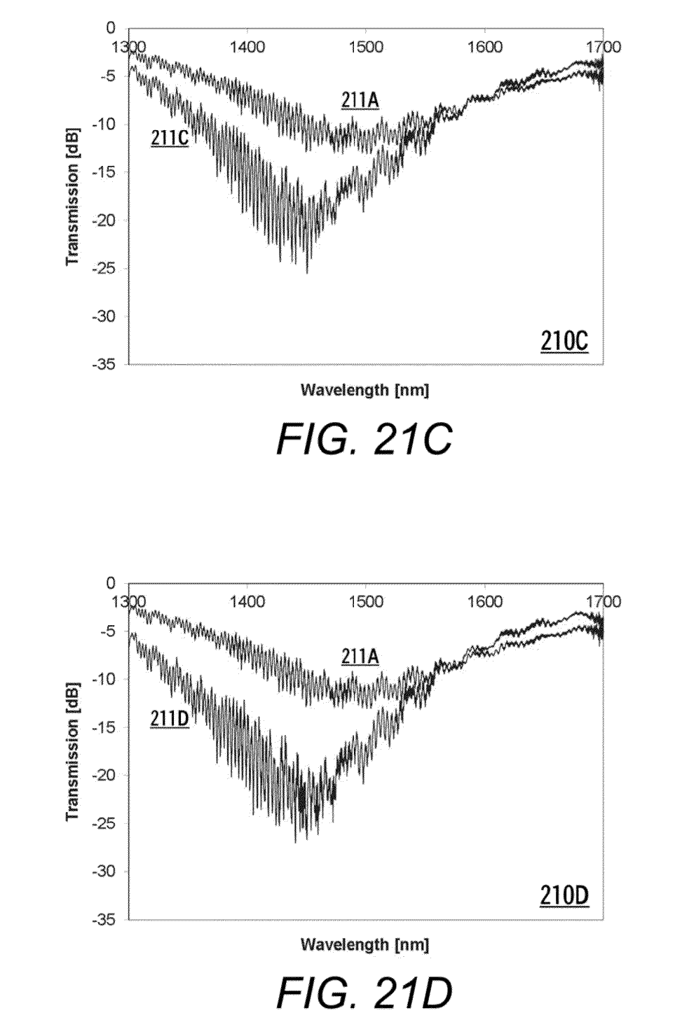

According to a further aspect of the invention, for easier and more precise control of index perturbations, an LPG is first fabricated with a greater perturbation than optimum. Subsequently, the LPG is annealed by passing the LPG multiple times by the heating element at a constant speed. The concept is illustrated in FIGS. 19-21.

FIG. 19 shows a graph 190 in which curve 191 depicts the relationship between heating time and perturbation. It will be seen that the ratio is non-linear. Additional heating time continues to produce an increase in perturbation, but the rate of increase decreases over time. Thus, in a post-writing annealing process, a fiber region that has already been perturbed will experience less change than the unperturbed part. The overall effect of annealing, therefore, is that the contrast of the grating pattern is weakened.

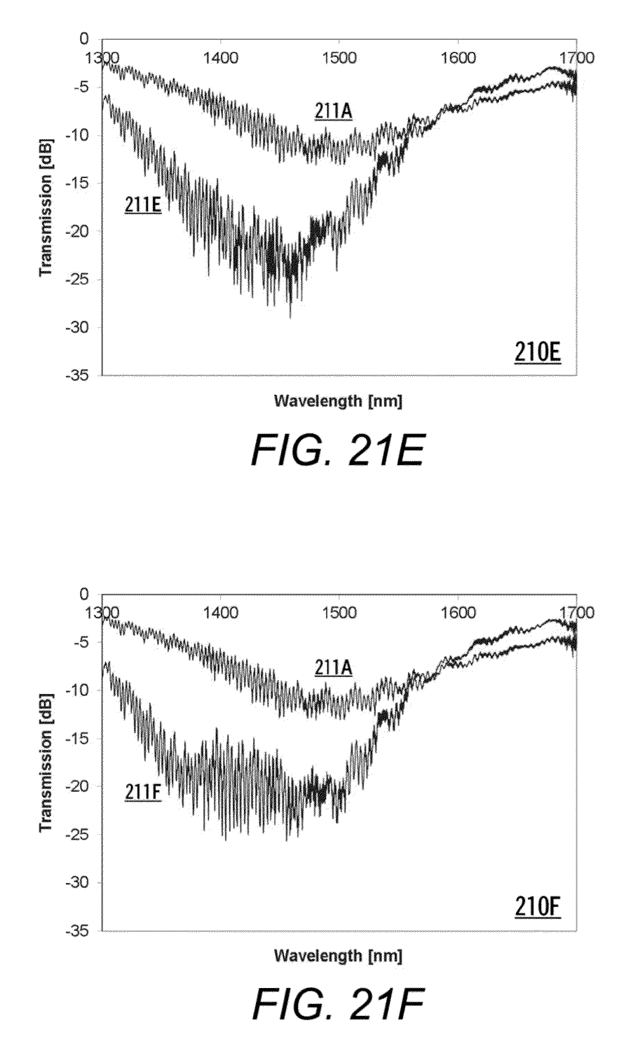

The weakening of the grating period is illustrated by plots 201 and 202 in the graph 200 shown in FIG. 20. The left plot 201 shows the pre-annealing index contrast 203 between the index of the initially non-perturbed fiber regions (indicated by broken line 203a) and the index perturbed fiber regions (indicated by broken line 203b). The right plot 202 shows the post-annealing index contrast 204 between the initially unperturbed regions 204a and the initially perturbed regions 204b.

As shown in graph 200, the annealing process increases the perturbation of the initially non-perturbed regions by an amount 205 that is greater than the amount 206 of the increase in perturbation of the initially perturbed regions. Thus, the annealed region has a lower index contrast than the annealed region.

A grating was made using a 0.5 mm platinum wire configured as shown in FIG. 11, and a translation assembly of the type shown in FIG. 12. The fiber used was that same as the one used in the other examples presented herein. The current through the platinum wire was 18.5 A. The fiber was kept still for 8 seconds and then moved to next position in 0.2 sec. The period was 1.14 mm. 5 periods where made corresponding to a grating length of 5.7 mm.

The grating was then annealed by passing the LPG by the heating wire with a speed of 1 mm/s and a current of 18.5 A through the platinum wire. The annealing process was repeated multiple times.

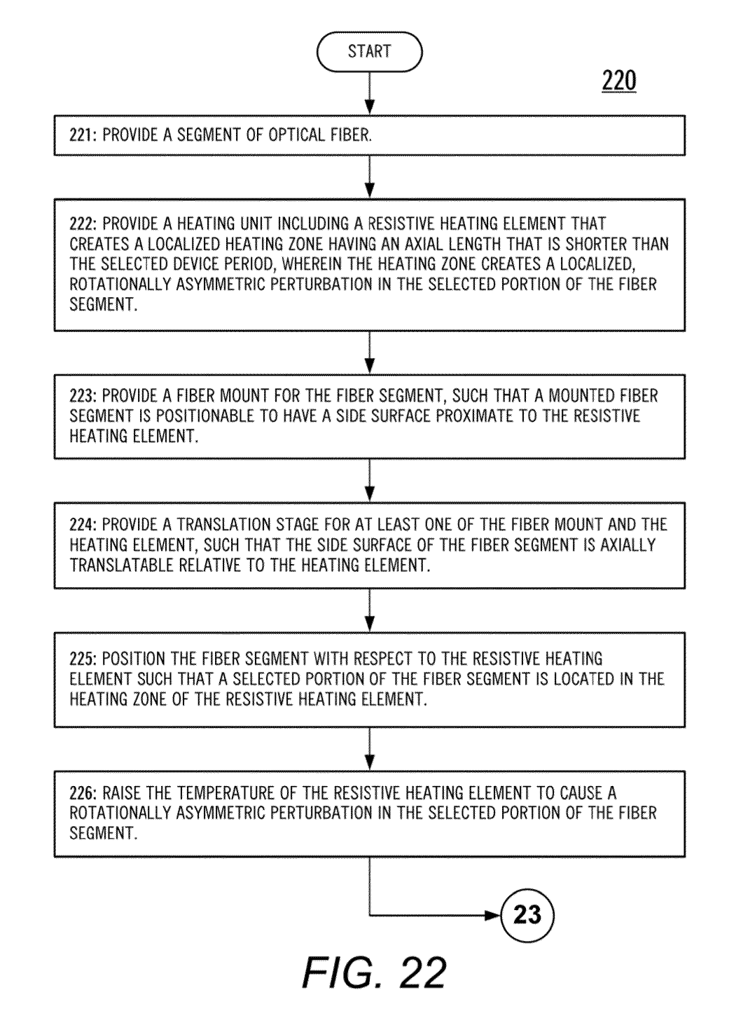

The transmission spectrum from LP₀₁-to-LP₀₁ was monitored during inscription and annealing using the testing setup shown in FIG. 13B. FIGS. 21A-21F are a series of graphs 210A-210F, showing the LP₀₁-to-LP₀₁ transmission spectra 211A-211F that were recorded after for each annealing pass. For convenient reference, the transmission spectrum after the first annealing pass 211A is repeated in FIGS. 21B-21F.

It was observed that, in the described practice of the invention, an optimum was reached after approximately five annealing passes. As can be seen in a visual comparison of FIGS. 21E and 21F, the sixth annealing pass results in a transmission spectrum 211F (FIG. 21F) that is noticeably flatter at 18 1400-1500 nm than the transmission spectrum 211E (FIG. 21E) recorded after the fifth annealing pass. In different situations, a different number of annealing passes, determined by trial and error, may be required to achieve an optimum result.

It will be appreciated that the described annealing technique is generally application for use with other systems and techniques for inscribing an LPG into an optical fiber. For example, the described annealing technique may be used in conjunction with the fabrication of symmetric gratings as described in U.S. Pat. No. 7,486,858, or in conjunction with the fabrication of asymmetric gratings using a CO₂ laser. Generally speaking, the described anneal technique may be used in conjunction with all grating writing systems and techniques in which the perturbation-versus-time curve has a nonlinear relationship, as illustrated in FIG. 19, discussed above.

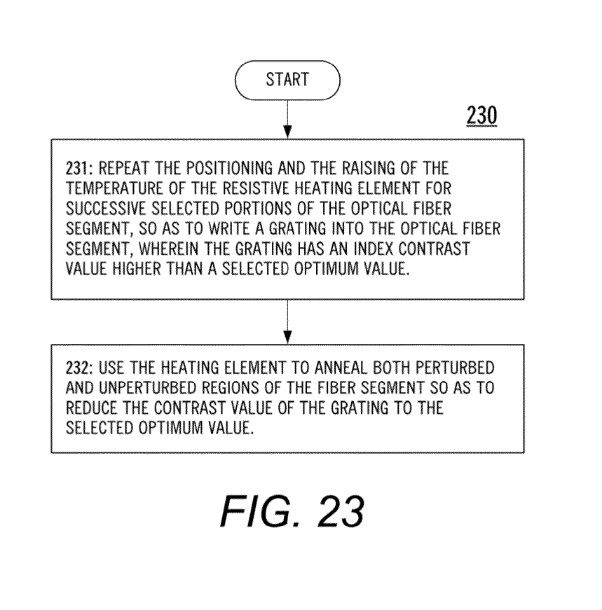

FIG. 22 shows a flowchart of a technique 220 for fabricating an LPG mode converter according to an aspect of the invention, and FIG. 23 shows a flowchart of an annealing technique 230 that can be performed in conjunction with technique 220.

It should be noted that FIGS. 22 and 23 are intended to be exemplary, rather than limiting. The present invention may be practiced in a number of different ways, using different combinations of some or all of the elements set forth in these drawings, as well as combinations including elements not explicitly set forth in these drawings. Further, the enumerated steps may be performed in a different order, or contemporaneously.

Technique 220 comprises the following steps:

221: Provide a segment of optical fiber.

222: Provide a heating unit including a resistive heating element that creates a localized heating zone having an axial length that is shorter than the selected device period, and that causes a localized, rotationally asymmetric perturbation in the selected portion of the fiber segment.

223: Mount the fiber segment so that a side surface of the fiber segment is proximate to a side surface of the resistive heating element;

224: Provide a translation stage for at least one of the fiber segment and the heating element, such that a side surface of the fiber segment is axially translatable relative to the heating element;

225: Position the fiber segment with respect to the resistive heating element such that a selected portion of the fiber segment is located in the heating zone of the resistive heating element.

226: Raise the temperature of the resistive heating element to cause a rotationally asymmetric perturbation in the selected portion of the fiber segment.

As set forth in in FIG. 9, technique 230 comprises the following steps that can be performed after step 226 of technique 220:

231: Repeat the positioning and the raising of the temperature of the resistive heating element for successive selected portions of the optical fiber segment, so as to write a grating into the optical fiber segment, while controlling the heating by the resistive heating element such that the grating is written with an index contrast value higher than a selected optimum value.

232: Use the heating element to anneal both perturbed and unperturbed regions of the fiber segment so as to reduce the contrast value of the grating to the selected optimum value.

It will be appreciated from the above described that the structures and techniques described herein provide a new and simple method for manufacturing of long period gratings based on thermal perturbation. In the described example, a practice of the invention was used to make an efficient and stable mode converter from LP₀₁ to LP₁₁. An insertion loss below 0.5 dB and MPI below −25 dB in a 20 nm range and bellow −20 dB between in a 40 nm range were obtained. Spatially and spectrally resolved imaging (“S² imaging”) was used as an effective and fast tool for characterization of the mode converters.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

We claim:

1. A method for writing an optical device into an optical fiber, the method comprising:
(a) providing a segment of optical fiber;
(b) providing a resistive heating element having a thickness less than a selected device period, wherein the resistive heating element will be used to create a localized heating zone having an axial length that is shorter than a selected device period;
(c) positioning the fiber segment so that a side surface of the fiber segment is proximate to a side surface of the resistive heating element;
(d) positioning the fiber segment with respect to the resistive heating element such that a selected portion of the fiber segment is located in the localized heating zone of the resistive heating element; and
(e) raising the temperature of the resistive heating element to cause a rotationally asymmetric perturbation in the selected portion of the fiber segment.

2. The method of claim 1, further comprising:
repeating the positioning and the raising of the temperature of the resistive heating element for successive selected portions of the optical fiber segment, so as to write a grating into the optical fiber segment.

3. The method of claim 1, wherein the fiber segment is translated across a surface of the resistive heating element.

4. The method of claim 1, wherein the resistive heating element is translated across a surface of the fiber segment.

5. The method of claim 1, further comprising:
applying a controlled tension to the fiber.

6. The method of claim 1, further comprising:
causing a geometrical perturbation in the selected portion of the fiber segment.

7. The method of claim 1, further comprising:
causing a localized refractive index modulation in the selected portion of the fiber segment.

8. The method of claim 7, further comprising:
providing a fiber segment having a draw-induced refractive index profile and a relaxed index profile, the application of heat to the selected portion of the fiber segment causing a localized change from the draw-induced refractive index profile to the relaxed index profile.

9. The method of claim 8, wherein the optical fiber has a refractive index profile that is optimized for index modulation using a resistive heating element.

10. The method of claim 9, further comprising:
tuning a value Δn(r) of the first refractive index profile by adjusting the amount of tension applied when the fiber is drawn.

11. The method of claim 1, further comprising:
shaping the resistive heating element to achieve an optimal heat profile and modulation shape along the length of the grating.

12. The method of claim 1, wherein the resistive heating element comprises a wire.

13. The method of claim 12, further comprising the step of using a curved wire is curved so as to guide movement of the fiber segment relative to the heating element.

14. The method of claim 12, further comprising the step of using a wire configured in an W-shape, so as to accommodate thermal expansion of the wire as the wire temperature is raised.

15. The method of claim 1, wherein the resistive heating element comprises a filament.

16. The method of claim 15, further comprising the step of having a notch in the filament for guiding the optical fiber segment.

17. The method of claim 1 further comprising the steps of:
(f) repeating the positioning and the raising of the temperature of the resistive heating element for successive selected portions of the optical fiber segment, so as to write a grating into the optical fiber segment, while controlling the heating by the resistive heating element such that the grating is written with an index contrast value higher than a selected optimum value; and
(g) using the heating element to anneal both perturbed and unperturbed regions of the fiber segment so as to reduce the contrast value of the grating to the selected optimum value.

18. The method of claim 17, wherein the annealing is repeated until the contrast value of the grating is reduced to the selected optimum value.

19. A system for writing an optical device into an optical fiber, the system comprising:
a resistive heating assembly, including a chassis and a pair of electrode blocks mounted thereto, the resistive heating assembly further including a resistive heating element mounted between the electrode blocks, wherein the resistive heating element creates a localized heating zone that has an axial length that is shorter than the selected device period, and that causes a localized, rotationally asymmetric perturbation in the selected portion of the fiber segment;
a mounting assembly for mounting the fiber segment so that a side surface of the fiber segment is proximate to a side surface of the resistive heating element;
a translation assembly, including a translation stage for at least one of the fiber segment and the heating element, such that a side surface of the fiber segment is axially translatable relative to the heating element;
a guide element for guiding the fiber.

20. The system of claim 19, further comprising:
a weight, attachable to the optical fiber, for pressing a surface of the optical fiber onto a surface of the heating element with a constant force.
